(19) United States
(12) Patent Application Publication
(10) Pub. No.: US 2007/0294683 A1
(43) Pub. Date: Dec. 20, 2007

(54) Methods of generating, linking and updating component-based software and information storage medium having such software recorded thereon

(75) Inventors: Jong-suk Lee, Suwon-si (KR); Sung-hyun Cho, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/641,056

(22) Filed: Dec. 19, 2006

(30) Foreign Application Priority Data
Jun. 15, 2006 (KR) 10-2006-0053894

(51) Int. Cl. G06F 9/44; G06F 9/45

(52) U.S. Cl. 717/162; 717/140

(57) ABSTRACT

Methods of providing component-based software in a plurality of binary images, linking the component-based software, and updating the component-based software, and an information storage medium having software recorded thereon are provided. The information storage medium having software recorded thereon includes at least one software component, a symbol table in which address information of symbols used by the software component is recorded, and memory map information recording memory address information indicating where the software component and the symbol table are loaded.

### CROSS-REFERENCE TO RELATED PATENT APPLICATION

This application claims priority from Korean Patent Application No. 10-2006-0053894, filed on Jun. 15, 2006, in the Korean Intellectual Property Office, the disclosure of which is incorporated herein in its entirety by reference.

### BACKGROUND OF THE INVENTION

1. Field of the Invention

The present invention relates to componentization of software, and more particularly, to methods of generating a component-based software in a plurality of binary images, linking component-based software, and updating the component-based software, and an information storage medium having software recorded thereon.

2. Description of Related Art

Various kinds of software are embedded in consumer electronics (CE) devices providing a variety of support functions. Since CE devices have limited memory capacity, it is necessary to develop software with less memory capacity. Since it is necessary to update software in order to correct errors or improve functions, software is designed to be upgraded. Therefore, research is being actively conducted to find a method of effectively upgrading software. There are two software update methods. One is to divide software into a plurality of components and update the components. Another is to change software in a binary image and update the binary image.

FIG. 1 is a block diagram of conventional component-based software. Referring to FIG. 1, an operating system (OS) 110 and three components 120, 130, and 140 are separated from each other and stored in a flash memory. When a system is booted up, the OS 110 is loaded to a RAM and the components 120, 130, and 140 requiring the OS 110 are loaded to the RAM. Since addresses of the components 120, 130, and 140 are not linked to each other, each of the components 120, 130, and 140 stores link information in a header 125. The link information is stored using an executable and linkable format (ELF) in a LINUX system or a VxWorks system. The link information is used at the time when each of the components 120, 130, and 140 are loaded to the RAM so that each of the components 120, 130, and 140 may be linked to a physical address of the RAM of the other components referred to by each of the components 120, 130, and 140.

Therefore, this structure has an advantage in that, since each of the components 120, 130, and 140 is easily managed and independent, a change in one of the components 120, 130, and 140 does not affect the other components. Software can also be effectively updated. For example, when the third component 140 is updated, a new version component 150 of the third component 140 is downloaded from a server and exchanged with an existing version of the third component 140. This makes it possible to effectively update software since load on a software update server is reduced, and an overall software image is not updated.

However, this structure has a disadvantage in that the size of a file of each of the components 120, 130, and 140 increases. In detail, since addresses of the components 120, 130, and 140 are not linked, it is necessary to record the link information of each of the components 120, 130, and 140 in the header of the file of each of the components 120, 130, and 140, which increases the size of the file by three or four times. The reason why the size of the file increases is that each of the components 120, 130, and 140 must include information about which part of the components 120, 130, and 140 uses exported and imported symbols in the header of each of the components 120, 130, and 140. Therefore, this structure is widely used in a system having no limited storage space, whereas it is impossible to apply this structure to CE devices having limited storage space. Also, since this structure takes a lot of time to link during compiling and runtime, it is more difficult to apply this structure to CE devices.

Therefore, most CE devices unify all software including the OS 110 as a large binary image, e.g., EXE, BIN, and store the binary image in a flash memory. In this case, although the size of the binary image can be reduced, an existing binary image must be entirely updated to allow a software version upgrade.

FIG. 2 is a block diagram of conventional software distributed as a binary image. Referring to FIG. 2, a file 210 that unifies an OS and three components is stored in a flash memory. When a system is booted up, the file 210 is loaded to a RAM. This structure does not require a symbol table or header information since a static address is designated to a symbol of each of the three components and the components are stored as a binary image 210. Therefore, since the size of the binary image can be minimized, this structure is suited to CE devices having limited storage space.

To update software stored in the binary image 210 state, a new binary image 220 is downloaded from a server and exchanged with the existing version file 210. However, a change in a part of each of the components requires the entire binary image to be updated. Since the symbol table or header information is not included in order to reduce the size of the binary image, all symbols are linked to the static address. Since the components are linked to each other using the static address, a small change in the binary image causes a large change in a file. Therefore, since an entire file is downloaded from a software update server, and the existing binary image 210 is backed up as a fail-safe backup of the file, a flash memory space must be twice as large as the size of the binary image.

### SUMMARY OF THE INVENTION

The present invention provides a method of effectively structuring a component-based software while occupying less memory space.

The present invention also provides methods of updating and linking component-based software in order to minimize the amount of data transmitted, the amount of flash memory used, and the time required to use the flash memory.

According to an aspect of the present invention, there is provided an information storage medium having software recorded thereon comprising: at least one software component; a symbol table on which address information of symbols used by the at least one software component is recorded; and memory map information on which memory address information, in which the at least one software component and the symbol table are loaded, is recorded.

The memory map information further may comprise memory address information in which an operation system (OS) is loaded.

The medium may further comprise: a symbol inquiry function called by the at least one software component and outputting access information on a symbol input by inquiring from the symbol table.

The access information on the input symbol may comprise an address of the input symbol in the symbol table, or a physical address of the input symbol in the at least one software component or in the OS.

The at least one software component may comprise codes referring to the symbol table in order to acquire a physical address of a symbol provided by the OS and other software components.

According to an aspect of the present invention, there is provided software arranging method comprising: generating at least one software component; generating a symbol table in which address information of symbols used by the at least one software component is recorded; and generating memory map information in which memory address information, in which an OS, the at least one software component, and the symbol table are loaded, is recorded.

According to an aspect of the present invention, there is provided a method of linking software including at least one software component based on memory map information on which memory address information, in which the at least one software component and a symbol table on which address information of symbols used by the at least one software component are loaded, is recorded.

According to an aspect of the present invention, there is provided a method of updating software including at least one software component linked based on memory map information in which memory address information, in which each component is loaded, is recorded, and a symbol table in which address information on symbols used by the at least one software component is recorded, the method comprising: updating a software component to be updated among the at least one software component; and updating the symbol table to reflect changed content of the updated software component.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of conventional component-based software;

FIG. 2 is a block diagram of conventional software distributed as a binary image;

FIG. 3 is a block diagram of component-based software according to an embodiment of the present invention;

FIG. 4 is a block diagram of a flash memory including component-based software according to an embodiment of the present invention;

FIG. 5 is a block diagram of RAM in which the software of FIG. 4 is loaded;

FIG. 6 is a diagram of codes used to call a function in a first component illustrated in FIG. 5;

FIG. 7 is a block diagram of component-based software according to another embodiment of the present invention;

FIG. 8 is a block diagram of a flash memory including the component-based software illustrated in FIG. 7;

FIG. 9 is a block diagram of RAM in which the software illustrated in FIG. 8 is loaded;

FIG. 10 is a diagram of the content of a symbol table according to an embodiment of the present invention;

FIG. 11 is a diagram of the content of a symbol table obtained by updating the symbol table illustrated in FIG. 10;

FIG. 12 is a diagram of codes used to call a function in a second component illustrated in FIG. 9;

FIG. 13 is a diagram for explaining a conventional function call principle;

FIG. 14 is a diagram for explaining an indirect function call principle according to an embodiment of the present invention;

FIG. 15 is a flowchart of a software arranging method according to an embodiment of the present invention;

FIG. 16 is a flowchart of a method of compiling and linking component-based software according to an embodiment of the present invention; and

FIG. 17 is a flowchart of a component-based software updating method according to an embodiment of the present invention.

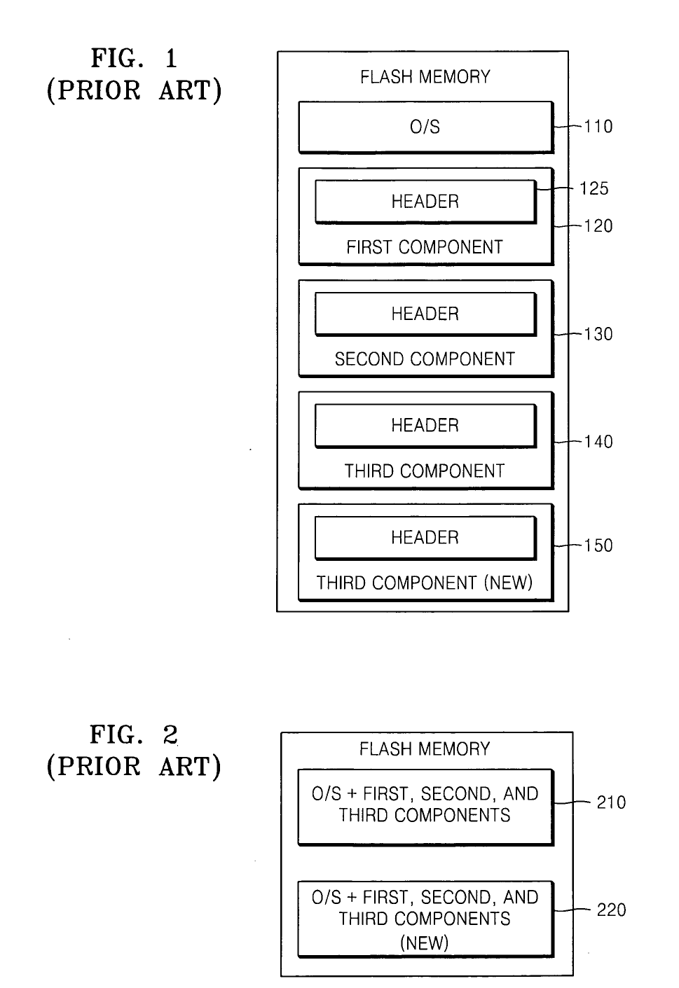

### DETAILED DESCRIPTION OF THE INVENTION

The present invention will now be described more fully with reference to the accompanying drawings, in which exemplary embodiments of the invention are shown.

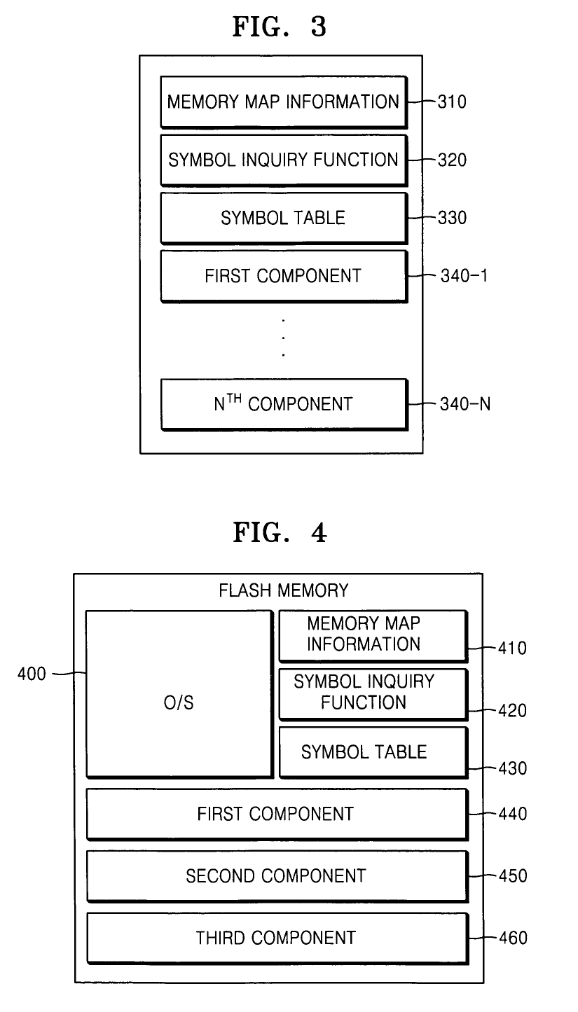

FIG. 3 is a block diagram of component-based software according to an embodiment of the present invention. In the current embodiment, a symbol inquiry function 320 that is a designated interface is used to provide each software component 340-1 through 340-N with independence.

Referring to FIG. 3, the software of the current embodiment of the present invention is divided into an operating system (OS—not shown) and a plurality of software components 340-1 through 340-N. The OS can be realized as one or more components among the software components 340-1 through 340-N. Unlike the conventional technique, each of the software components 340-1 through 340-N does not include header information for linking, but is already linked using memory map information 310. Since the software components 340-1 through 340-N are previously linked, they do not require the header information but use storage spaces similar to that of a software which is conventionally realized in a binary image.

The software of the current embodiment of the present invention includes a symbol table 330 recording address information of symbols used by each of the software components 340-1 through 340-N and the memory map information 310 recording address information of RAM in which the software components 340-1 through 340-N and the symbol table 330 are loaded. The memory map information 310 further includes a memory address of RAM in which the OS and the symbol inquiry function 320 are loaded. The memory map information 310 is used to link the software and load the software to the RAM.

As described above, the software of the current embodiment of the present invention further includes the symbol inquiry function 320 that finds symbols (functions, global variables, etc.) provided by each of the software components 340-1 through 340-N outside. The symbol inquiry function 320, which is a common interface called by the software components 340-1 through 340-N, inquires the symbol table 330 and outputs access information such as addresses of symbols to be used by each of the software components 340-1 through 340-N. Binary images of each of the software components 340-1 through 340-N call the symbol inquiry function 320 using addresses in which the symbol inquiry function 320 is loaded. The symbol inquiry function 320 returns addresses of input symbols in the symbol table 330 or physical addresses of input symbols in the software components 340-1 through 340-N or in the OS. The software components 340-1 through 340-N that called the symbol inquiry function 320 use desired symbols based on the returned information.

FIG. 4 is a block diagram of a flash memory including component-based software according to an embodiment of the present invention. Referring to FIG. 4, three previously linked software components 440, 450, and 460 are installed in the flash memory. The flash memory further includes memory map information 410, a symbol inquiry function 420, and a symbol table 430, which are separated from an OS 400. However, the memory map information 410, the symbol inquiry function 420, and the symbol table 430 can be included in the OS 400.

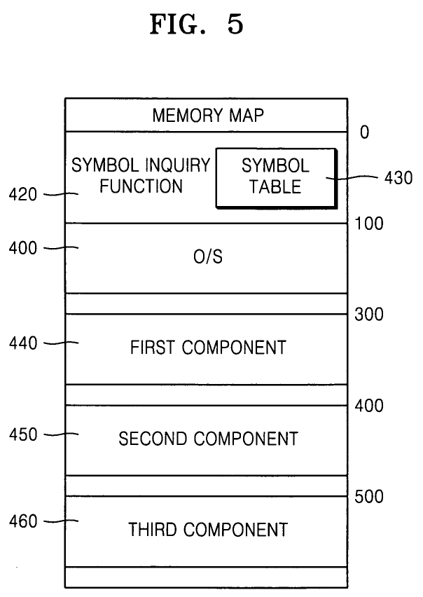

FIG. 5 is a block diagram of a RAM in which the software illustrated in FIG. 4 is loaded. Referring to FIG. 5, each of the constituents is loaded into a designated memory space based on the memory map information 410.

Since the three software components 440, 450, and 460 are mapped and linked based on addresses designated in the memory map information 410, if they are loaded in memory spaces having a different base address, an error occurs. The symbol inquiry function 420 and the symbol table 430 are loaded from address 0, the OS 400 is loaded from address 100, the first component 440 is loaded from address 300, the second component 450 is loaded from address 400, and the third component 460 is loaded from address 500.

The component-based software of the present invention is not dynamically linked, but is linked previous to it being loaded to RAM. When one of the software components 440, 450, and 460 refers directly to a function address of another software component, if the function address is changed due to the correction of another component, the software component that refers to another component needs to be modified. Therefore, each of the software components 440, 450, and 460 communicates using the symbol inquiry function 420 which is a designated interface, and they can be thereby independently managed. Since each of the software components 440, 450 and 460 uses the function address of another software component through the designated interface 420, a change in the function address of another software component does not influence the software component that refers to the other software component.

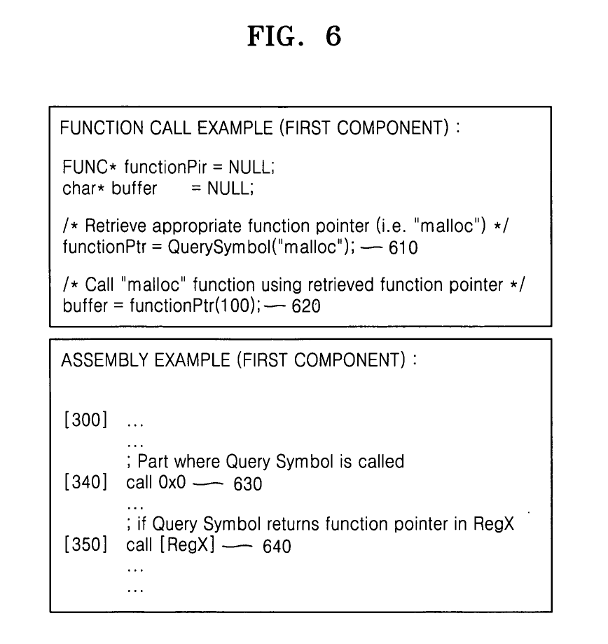

FIG. 6 is a diagram of codes used to call a function in the first component 440 illustrated in FIG. 5.

A conventional technique calls a function by using an instruction such as “malloc 100” in order to call a function for memory allocation (malloc). However, referring to FIG. 6, in the current embodiment of the present invention, the code first calls QuerySymbol that is a symbol inquiry function, receives a function pointer with regard to a function malloc 610, and calls the malloc using the returned function pointer 620.

The method results in independence between components, which can be confirmed from codes provided using an assembly language. Assembly codes 630 and 640 correspond to function calls 610 and 620. A “call” instruction word is used to call a function stored in a related address. Instruction word routines necessary for executing a function from the related address are included in the codes.

A first call instruction word 630 calls QuerySymbol using an absolute value address 0x0. A second call instruction word 640 calls a malloc that is a function of another component using a calculated address [RegX]. If an address of QuerySymbol that is the symbol inquiry function is designated as static, since the first call instruction word 630 is not changed, it is not necessary to correct a component referring to another component. [RegX] indicates that the address of malloc included in a symbol table is included in [RegX]. However, the second call instruction word 640 can refer to a physical address of the malloc in another embodiment of the present invention. Also, the current embodiment of the present invention describes the function malloc provided by an OS. However, when a function of another component is used, access information of a desired function is acquired using the symbol inquiry function according to the same principle in order to use the desired function.

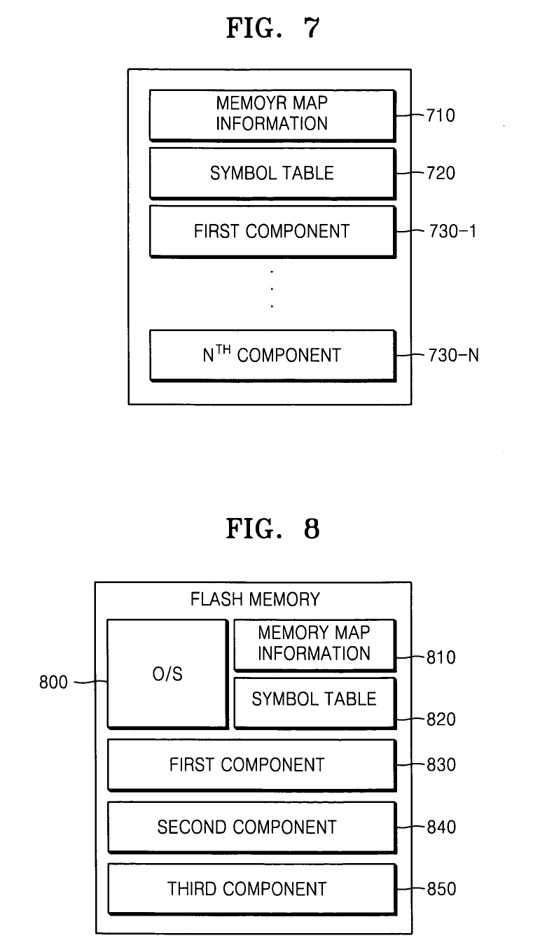

FIG. 7 is a block diagram of component-based software according to another embodiment of the present invention. Referring to FIG. 7, a symbol inquiry function is not used and a linker is modified so that a binary image of software components 730-1 through 730-N are linked to include a code referring to a symbol table 720 in order to acquire physical addresses of symbols provided by an OS and other software components. The component-based software of the previous embodiment illustrated in FIG. 3 includes both an instruction word calling the symbol inquiry function and an instruction word calling a function to be used in order to call an external function.

However, unlike the previous embodiment illustrated in FIG. 3, the component-based software of the current embodiment of the present invention does not include the symbol inquiry function but instead includes memory map information 710, the symbol table 720, and one or more software components 730-1 through 730-N. Like the previous embodiment illustrated in FIG. 3, an OS can be realized as one or more components among these software components 730-1 through 730-N.

The memory map information 710 includes address information on RAM in which the symbol table 720, the OS, and each of the software components 730-1 through 730-N are loaded, and is used to link the OS and each of the software components 730-1 through 730-N, and load the OS and each of the software components 730-1 through 730-N to the RAM. When each of the software components 730-1 through 730-N is linked, the physical addresses are designated based on an address of a currently executed instruction word and symbol address information of the symbol table 720. Therefore, the address of the currently executed instruction word and the symbol address information of the symbol table 720 are important information for executing each instruction word of the software components 730-1 through 730-N. The memory map information 710 is used to designate a base address of each of the software components 730-1 through 730-N.

The symbol table 720 stores address information of symbols used by each of the software components 730-1 through 730-N. A function and variable used by each of the software components 730-1 through 730-N are linked with the software component by using an address designated in the symbol table 720. For example, when a function printf is used, a conventional link method directly links an address beginning with the function printf and a software component using the function printf. However, in the current embodiment of the present invention, an address of the symbol table 720 in which an address of the function prinf is recorded is linked with the software component using the function printf. Therefore, when each of the software components 730-1 through 730-N is updated, it is necessary to simultaneously update the symbol table 720 stored in the flash memory. The symbol table 720 must be updated in order to support dynamic loading.

FIG. 8 is a block diagram of a flash memory including the component-based software illustrated in FIG. 7. Referring to FIG. 8, three previously linked software components 830, 840, and 850 are installed in the flash memory. The flash memory further includes memory map information 810 and a symbol table 820, which are separated from an OS 800. However, the memory map information 810 and the symbol table 820 can be included in the OS 800.

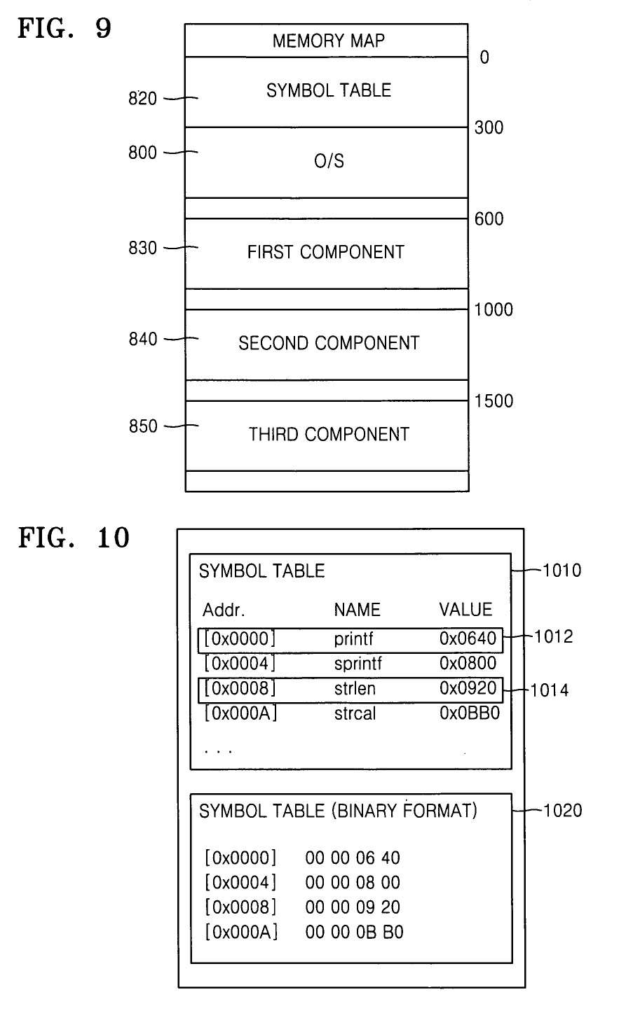

FIG. 9 is a block diagram of a RAM in which the software of FIG. 8 is loaded. Referring to FIG. 9, each constituent is loaded in a designated memory space based on the memory map information 810.

The symbol inquiry function 820 is loaded from address 0, the OS 800 is loaded from address 300, the first component 830 is loaded from address 600, the second component 840 is loaded from address 1000, and the third component 850 is loaded from address 1500.

FIG. 10 is a diagram of the content of a symbol table 1010 according to an embodiment of the present invention. Referring to FIG. 10, the symbol table 1010 includes an address value of each symbol. For example, the symbol table 1010 shows that a function printf begins with address 0x0640 (1012), and a function strlen begins with address 0x0920 (1014). A symbol name is indicated for reference and is not required to be stored in the symbol table 1010 since a dynamic link method is not used but instead a relating address is previously linked, in the current embodiment of the present invention. A lower portion 1020 is expressed as a binary format of the symbol table 1010. In the lower portion 1020, an address of each symbol uses only 4 bytes.

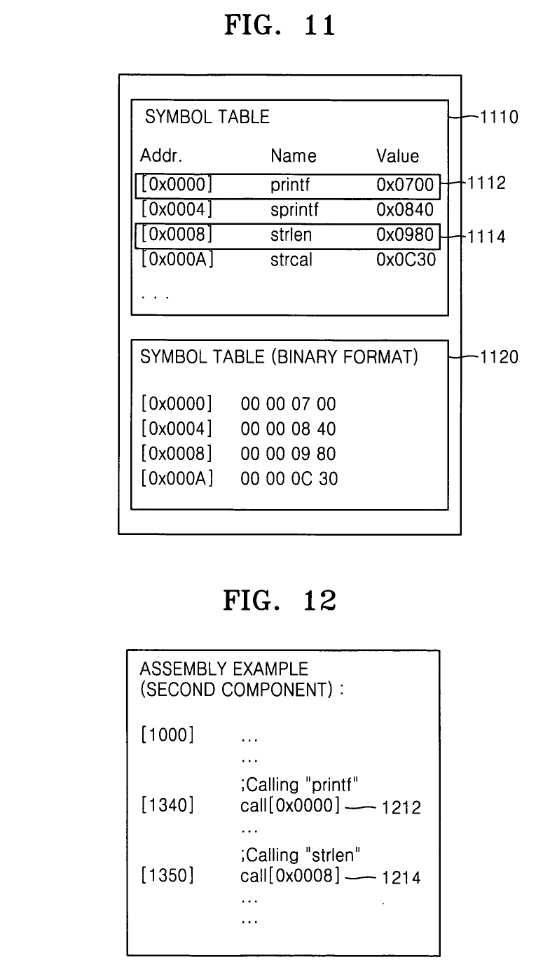

FIG. 11 is a diagram of the content of a symbol table 1110 obtained by updating the symbol table illustrated in FIG. 10. Referring to FIG. 11, a beginning address of the function prinft is changed to 0x700 (1112), and a beginning address of the function strlen is changed to 0x980 (1114) since an OS providing these functions is updated. Like the symbol table 1010 illustrated in FIG. 10, a lower portion 1120 is expressed as a binary format of the symbol table 1110.

FIG. 12 is a diagram of codes used to call a function in the second component 840 illustrated in FIG. 9. Referring to FIG. 12, assembly codes do not require an instruction word that calls a symbol inquiry function, unlike the codes illustrated in FIG. 6. An instruction word calling a function printf is compiled and linked to an assembly instruction word 1212 referred to by address 0x0000 of a symbol table on which a beginning address of the function print is recorded. An instruction word calling a function strlen is compiled and linked to an assembly instruction word 1214 referred to by address 0x0008 of a symbol table on which a beginning address of the function strlen is recorded. These call instructions words 1212 and 1214 operate so as to be redirected to addresses storing the functions printf and strlen through the symbol table. In detail, the call instruction words jump to the functions printf and strlen by writing an address of a necessary function in the symbol table using an indirect addressing method. In this regard, if the location (address) of the symbol table is not changed, a software component using a symbol is not affected but a symbol link is properly accomplished by updating the software component and the symbol table including the symbol.

Although address values of the symbol table 1110 are changed after the OS providing the functions printf and strlen is updated, it is not necessary to update the second component 840 using the functions printf and strlen. Since addresses of the symbol table 1110 are not changed, it is not necessary to update software components using symbols that indirectly call a function using information 1112 recorded in address 0x0000 and information 1114 recorded in address 0x0008 of the symbol table. To this end, the addresses of the symbol table must not be changed but a new symbol is added to the last of the symbol table. As described above, the symbol table must be always loaded to an address designated in memory map information.

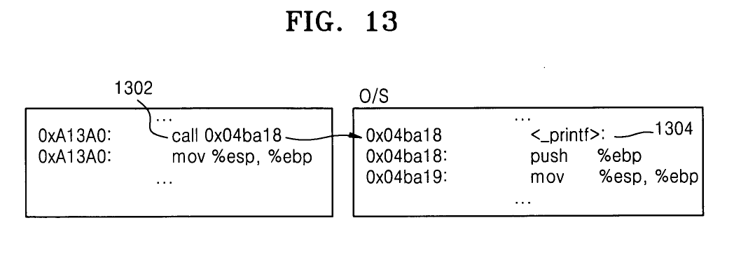

FIG. 13 is a diagram for explaining a conventional function call principle. Referring to FIG. 13, a conventional call instruction word 1302 directly diverges into an address 1304 including a function printf.

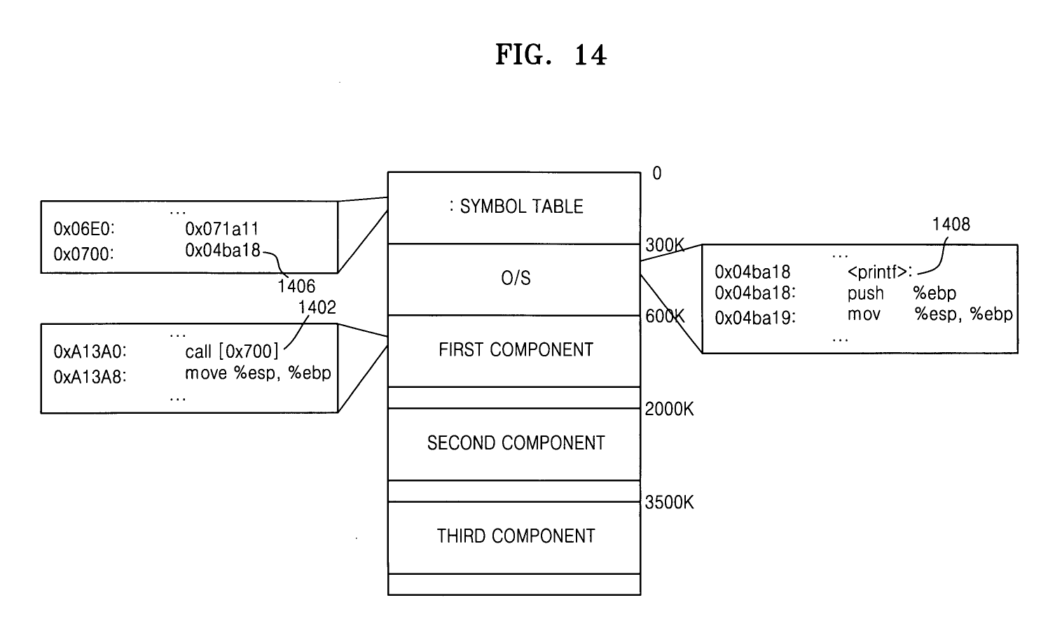

FIG. 14 is a diagram for explaining an indirect function call principle according to an embodiment of the present invention. Referring to FIG. 14, addresses of a symbol table on which an address of a function is recorded are used in the current embodiment of the present invention. That is, a depth is added. When a first component calls a function printf, the first component is changed to have an instruction word 1402 referring to a symbol table item of address 0x700. Since the address 0x700 of the symbol table includes an item 1406 on which address 0x04ba18 of an OS is recorded, “call [0x700]” calls a function printf 1408 beginning with the address 0x04ba18.

Although functions provided by an OS are described in the current embodiment, it is obvious that functions provided by the software components are used in the same manner as described in the current embodiment.

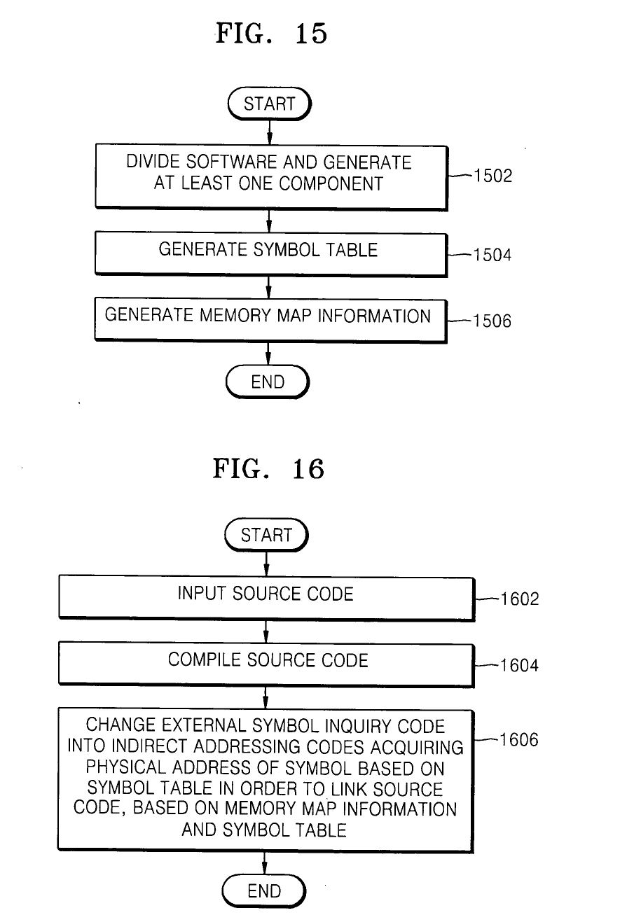

FIG. 15 is a flowchart of a method for deriving a component-based software according to an embodiment of the present invention. Referring to FIG. 15, software is divided in order to generate at least one software component (Operation 1502). In this regards, it should be appreciated that the same method can be used in cases where the software was originally written in component form, in which case the software dividing step can be omitted. A symbol table is generated, on which address information of symbols used by the generated software component is recorded, (Operation 1504). Memory map information is generated, on which memory address information in which an OS, the software component, and the symbol table are loaded is recorded (Operation 1506).

The component-based software generating method can further include an operation of generating a symbol inquiry function that is called by the at least one software component and outputs access information of a symbol input by interrogating the symbol table. The symbol access information can include an address of the input symbol in the symbol table, or a physical address of the input symbol in a software component or in the OS. According to another embodiment of the present invention, the software component can include codes referring to the symbol table in order to acquire a physical address of a symbol provided by an OS and other software components.

FIG. 16 is a flowchart of a method of compiling and linking component-based software according to an embodiment of the present invention. Referring to FIG. 16, input source codes are compiled (Operations 1602 and 1604), and then linked (Operation 1606). Based on memory map information and a symbol table, external symbol inquiry codes of the input source codes are changed into indirect addressing codes acquiring a physical address of a symbol based on the symbol table in order to perform a linking process (Operation 1606).

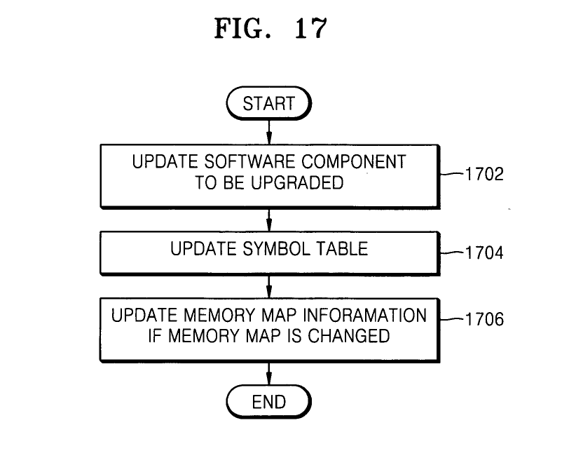

FIG. 17 is a flowchart of a component-based software updating method according to an embodiment of the present invention. Each software component of the component-based software according to the present invention can be independently updated. Therefore, an entire software image is not updated but instead only the changed components and changed symbol table are updated.

Referring to FIG. 17, all software components are not updated but software components to be changed and upgraded are updated (Operation 1702). A symbol table is updated to reflect changed content of the updated software components (Operation 1704). If a memory address in which each software component is loaded is changed, memory map information is updated (Operation 1706).

When all external functions are called using an indirect method, a problem in terms of performance of the software must be considered. The more frequently a function is used, the more serious the problem becomes. Although external component functions are not frequently called, functions provided by an OS are frequently called, which can influence the performance of the software. To address this problem, the functions provided by the OS cannot be called indirectly but must be called directly. If the functions provided by the OS are indirectly called, since components are correlated, the functions provided by the OS cannot be corrected, and a base address of the OS designated in the memory map information cannot be changed.

However, an experiment shows that the indirect calling method of the present invention does not greatly reduce the performance of the software. When a binary image generated from software having 1303 external function calls is executed in VxWorks, the size of the binary image is 974 KB and an average tick count of the binary image is 1594 (26.57 sec). Meanwhile, when the software having 1303 external function calls is component-based according to the present invention and executed in the same platform VxWorks, the size of the binary image is 978 KB and the average tick count is 1615 (26.9 sec). Therefore, according to the present invention, memory having a similar size to that of software generated using a binary image is required and an execution speed is also almost to the same as the binary image software, and both advantages of software provided as a binary image and component-based software can be used.

The present invention can also be embodied as computer readable code on a computer readable recording medium.

According to the present invention, an increased file size due to symbol information used to convert a binary image software into component-based software is reduced.

Also, since a binary image software is divided into several componenets, only changed components need to be updated in order to upgrade software, thereby reducing the amount of data downloaded from a server, greatly reducing a backup file size for a fail-safe update, and improving an update speed, so that software can be effectively updated.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An information storage medium having component-based software recorded thereon, comprising:
at least one software component;
a symbol table on which address information of symbols used by the at least one software component is recorded; and
memory map information on which memory address information of the at least one software component and the symbol table is recorded.

2. The medium of claim 1, wherein the memory map information further comprises memory address information of an operation system (OS).

3. The medium of claim 1, further comprising: a symbol inquiry function that when called upon by the at least one software component, interrogates the symbol table and outputs access information of an input symbol.

4. The medium of claim 3, wherein the access information of the input symbol comprises an address of the input symbol in the symbol table, or a physical address of the input symbol in the at least one software component or in the OS.

5. The medium of claim 1, wherein the at least one software component comprises codes referring to the symbol table in order to acquire a physical address of a symbol provided by the OS and other software components.

6. A method for handling a software program, comprising:
generating at least one software component by dividing the software program;
generating a symbol table in which address information of symbols used by the at least one software component is recorded; and
generating memory map information in which memory address information is recorded for an OS, the at least one software component, and the symbol table.

7. The method of claim 6, further comprising: generating a symbol inquiry function that when it is called upon by the at least one software component said function interrogates the symbol table and outputs access information of an input symbol.

8. The method of claim 7, wherein the access information of the input symbol comprises an address of the input symbol in the symbol table, or a physical address of the input symbol in the at least one software component or in the OS.

9. The method of claim 6, wherein the at least one software component comprises codes referring to the symbol table in order to acquire a physical address of a symbol provided by the OS and other software components.

10. A method of linking software including at least one software component, comprising:
providing a memory map;
recording in the memory map memory address information for the at least one software component;
providing a symbol table;
recording on the symbol table address information of symbols used by the at least one software component.

11. The method of claim 10, wherein a symbol inquiry code of the at least one software component is changed to a code acquiring physical addresses of the symbols based on the symbol table.

12. A computer readable recording medium having embodied thereon a computer program for executing a method of linking software including at least one software component, the program causing the computer to execute the steps comprising:
generating a memory map;
storing in the memory map memory address information;
generating a symbol table;
storing in the symbol table address information of symbols used by the at least one software component;
wherein a symbol inquiry code of the at least one software component is changed to a code acquiring physical addresses of the symbols based on the symbol table.

13. A method of updating software including at least one software component linked based on memory map information in which memory address information indicating where each component is loaded is recorded, and a symbol table in which address information on symbols used by the at least one software component is recorded, the method comprising:
updating a software component to be updated among the at least one software component; and
updating the symbol table to reflect changed content of the updated software component.

14. The method of claim 13, further comprising: updating the memory map information if memory addresses, in which each component is loaded, are changed.

15. A computer readable recording medium having embodied thereon a computer program for executing a method of updating software including at least one software component linked based on memory map information in which memory address information indicating where each of components is loaded is recorded, and a symbol table in which address information of symbols used by the at least one software component is recorded, the method comprising:
updating a software component to be updated among the at least one software component;
updating the symbol table to reflect changed content of the updated software component; and
updating the memory map information if memory addresses, in which each of the components is loaded, are changed.
